(19) United States
(12) Patent Application Publication
(10) Pub. No.: US 2022/0283583 A1
(43) Pub. Date: Sep. 8, 2022

(54) OBTAINING AND UTILIZING POWER DEMAND DATA OF SELF-PROPELLED VEHICLES

(71) Applicant: Javier Zamora, Waukesha, WI (US)

(72) Inventor: Javier Zamora, Waukesha, WI (US)

(21) Appl. No.: 17/225,019

(22) Filed: Apr. 7, 2021

Related U.S. Application Data
(60) Provisional application No. 63/155,414, filed on Mar. 2, 2021.

(51) Int. Cl. G05D 1/00; B63B 79/40; B63B 79/10; B63H 1/14; G05D 1/02

(52) U.S. Cl. CPC G05D 1/0088; B63B 79/40; B63B 79/10; B63H 1/14; G05D 1/0206

(57) ABSTRACT

A system includes a memory device and a processing device. The processing device is operatively coupled to the memory device to perform operations, including receiving a set of data associated with operation of a self-propelled vehicle, obtaining power demand data based on the set of data, and utilizing the power demand data within one or more applications related to the self-propelled vehicle.

### RELATED APPLICATIONS

This application claims the benefit of U.S. Provisional Application No. 63/155,414, filed Mar. 2, 2021, the entire contents of which are incorporated by reference.

### TECHNICAL FIELD

The present disclosure is generally related to self-propelled vehicles, and more particularly, to obtaining and utilizing power demand data of self-propelled vehicles.

### BACKGROUND

A self-propelled vehicle is a vehicle that includes machinery enabling locomotion through the use of motors, engines, propellers, etc. One example of a self-propelled vehicle is a self-propelled vessel. Self-propelled vessels are vessels (e.g., ships or large boats) that generally utilize hydraulic motors/engines, in combination with propellers and/or other propulsion means, to provide propulsion through a fluid (e.g., water). Self-propelled vehicles can be manned vehicles and/or autonomous/self-driving vehicles.

### SUMMARY

The following is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In accordance with an embodiment, a system is provided. The system includes a memory device, and a processing device, operatively coupled to the memory device, to perform operations. The operations include receiving a set of data associated with operating a self-propelled vehicle, obtaining power demand data based on the set of data, and utilizing the power demand data within one or more applications related to the self-propelled vehicle.

In accordance with another embodiment, a method is provided. The method includes receiving, by a processing device, a set of data associated with operating a self-propelled vehicle, obtaining, by the processing device, power demand data based on the set of data, and utilizing, by the processing device, the power demand data within one or more applications related to the self-propelled vehicle.

In accordance with yet another embodiment, a non-transitory computer-readable storage medium is provided. The non-transitory computer-readable storage medium includes instructions that, when executed by a processing device, cause the processing device to perform operations. The operations include receiving a set of data associated with operating a self-propelled vehicle, obtaining power demand data based on the set of data, and utilizing the power demand data within one or more applications related to the self-propelled vehicle.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example computer system architecture, in accordance with some embodiments.

FIG. 2 depicts a flow diagram of a method for obtaining and utilizing power demand data of a self-propelled vehicle, in accordance with some embodiments.

FIG. 3 depicts a flow diagram of a method for evaluating the performance of a self-propelled vessel, in accordance with some embodiments.

FIG. 4 depicts a block diagram of a system including a self-propelled vehicle and power demand utilization sub-system, in accordance with some embodiments.

FIG. 5 depicts a block diagram of an illustrative computer system operating in accordance with one or more aspects of the present disclosure.

FIG. 6 depicts graphs of synthetic data plotted over a year period, in accordance with some embodiments.

FIG. 7 depicts graphs of synthetic data corresponding to a thirty day moving window extracted from the graphs of FIG. 6, in accordance with some embodiments.

FIG. 8 depicts graphs illustrating power demand over the year period based on the synthetic data shown in FIG. 6, in accordance with some embodiments.

### DETAILED DESCRIPTION

It can be challenging to estimate the power demand of a self-propelled vehicle. For example, with respect to a self-propelled vessel, many parameters used to estimate the power demand of the self-propelled vessel can only be measured in the towing tank, where the tests are performed in a controlled environment. Once the full-scale, self-propelled vessel is built and set to sail, the measurement of such parameters is no longer possible, and methods for accurately predicting the power demand required to achieve a particular speed under operational sailing conditions are presently unknown. The challenge overall first resides in the huge variability range of the ever-changing operational sailing conditions. Examples of operational sailing conditions include draft, trim, list, wind, waves, currents, hull roughness, etc. Second, captains may manage their ships responding similarly under similar environmental conditions, thus introducing a level of sampling bias that nullifies the validity of the prediction made by any statistical or machine learning approach beyond the data that was provided.

Aspects of the present disclosure address the above noted and other deficiencies by obtaining and utilizing power demand data of self-propelled vehicles. In some embodiments, the self-propelled vehicles are self-propelled vessels (e.g., ships, boats, submarines). In such embodiments, the power demand of a self-propelled vessel can be accurately predicted under any operational sailing conditions, even with limited vessel data availability or without any previous information of the particulars of the self-propelled vessel.

The embodiments described herein can be used to obtain a power demand of self-propelled vehicles as a function of environmental conditions and known characteristics of the vehicle propulsion means. For example, the embodiments described herein can be used to obtain the power demand of self-propelled vessels as a function of sailing conditions and known characteristics of propellers. The power demand data can include a shaft power demand and/or an effective power demand.

The embodiments described herein can be used within a variety of implementations associated with self-propelled vehicle performance optimization. Examples of such implementations include, but are not limited to, vehicle performance evaluation, vehicle and propulsion design (e.g., vessel and propeller design), autonomous or self-driving vehicle energy usage optimization, autonomous passive navigation without a Global Positioning System (GPS), simultaneous localization for autonomous underwater vehicles (e.g., autonomous submarines), automatic draft determination, minimization of propeller noise signatures, controllers for hybrid electric autonomous vehicles, real-time turbulence recognition systems for autonomous vehicles, etc. Additionally, the embodiments described herein can reduce the amount of fuel consumption of self-propelled vehicles. By reducing fuel consumption, the embodiments described herein can reduce self-propelled vehicle operating costs and reduce the carbon footprint of self-propelled vehicles.

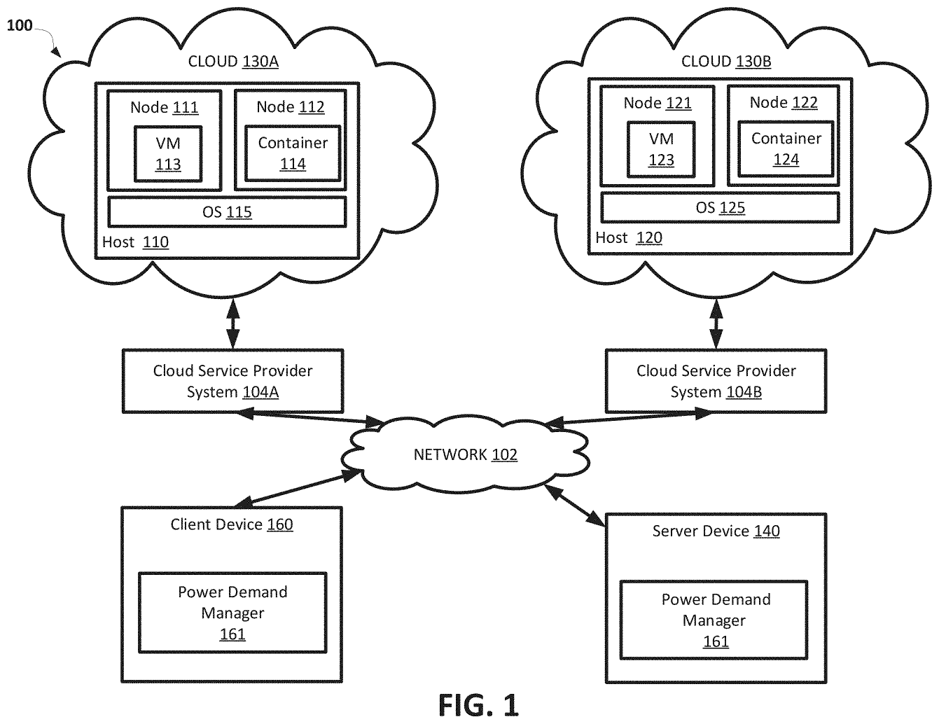

FIG. 1 is a block diagram of a network architecture 100 in which implementations of the disclosure may operate. In some implementations, the network architecture 100 may include a Platform-as-a-Service (PaaS) system and/or a Software-as-a-Service (SaaS). The network architecture 100 provides resources and services (e.g., micro-services) for the development and execution of applications owned or managed by multiple users. The network architecture 100 provides a platform and environment that allows users to build applications and services in a clustered compute environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes one or more cloud-computing environments 130A, 130B (also referred to herein as a cloud(s)) that include nodes 111, 112, 121, 122 to execute applications and/or processes associated with the applications. A “node” providing computing functionality may provide the execution environment for an application of the PaaS and/or SaaS system. In some implementations, the “node” may include a virtual machine (VMs 113, 123) that is hosted on a physical machine, such as host 110, 120 implemented as part of the clouds 130A, 130B. For example, nodes 111 and 112 are hosted on a physical machine of host 110 in cloud 130A provided by cloud provider 104A. Similarly, nodes 121 and 122 are hosted on a physical machine of host 120 in cloud 130B provided by cloud provider 104B. In some implementations, nodes 111, 112, 121, and 122 may additionally or alternatively include a group of VMs, a container (e.g., container 114, 124), or a group of containers to execute the functionality of the PaaS applications. When nodes 111, 112, 121, 122 are implemented as VMs, they may be executed by operating systems (OS's) 115, 125 on each host machine 110, 120. It should be noted that while two cloud provider systems have been depicted in FIG. 1, in some implementations, more or fewer cloud service provider systems 104 (and corresponding clouds 130) may be present.

In some implementations, the host machines 110, 120 can be located in data centers. Users can interact with applications executing on the cloud-based nodes 111, 112, 121, 122 using client computer systems (not pictured) via corresponding client software (not pictured). Client software may include an application such as a web browser. In other implementations, the applications may be hosted directly on hosts 110, 120 without the use of VMs (e.g., a “bare metal” implementation), and in such an implementation, the hosts themselves are referred to as “nodes”.

In various implementations, developers, owners, and/or system administrators of the applications may maintain applications executing in clouds 130A, 130B by providing software development services, system administration services, or other related types of configuration services for associated nodes in clouds 130A, 130B. This can be accomplished by accessing clouds 130A, 130B using an application programmer interface (API) within the applicable cloud service provider system 104A, 104B. In some implementations, a developer, owner, or system administrator may access the cloud service provider system 104A, 104B from a client device (e.g., client device 160) that includes dedicated software to interact with various cloud components. Additionally, or alternatively, the cloud service provider system 104A, 104B may be accessed using a web-based or cloud-based application that executes on a separate computing device (e.g., server device 140) that communicates with client device 160 via network 102.

Client device 160 is connected to hosts 110 in cloud 130A and host 120 in cloud 130B and the cloud service provider systems 104A, 104B via a network 102, which may be a private network (e.g., a local area network (LAN), a wide area network (WAN), intranet, or other similar private networks) or a public network (e.g., the Internet). Each client 160 may be a mobile device, a PDA, a laptop, a desktop computer, a tablet computing device, a server device, or any other computing device. Each host 110, 120 may be a server computer system, a desktop computer, or any other computing device. The cloud service provider systems 104A, 104B may include one or more machines such as server computers, desktop computers, etc. Similarly, server device 140 may include one or more machines such as server computers, desktop computers, etc.

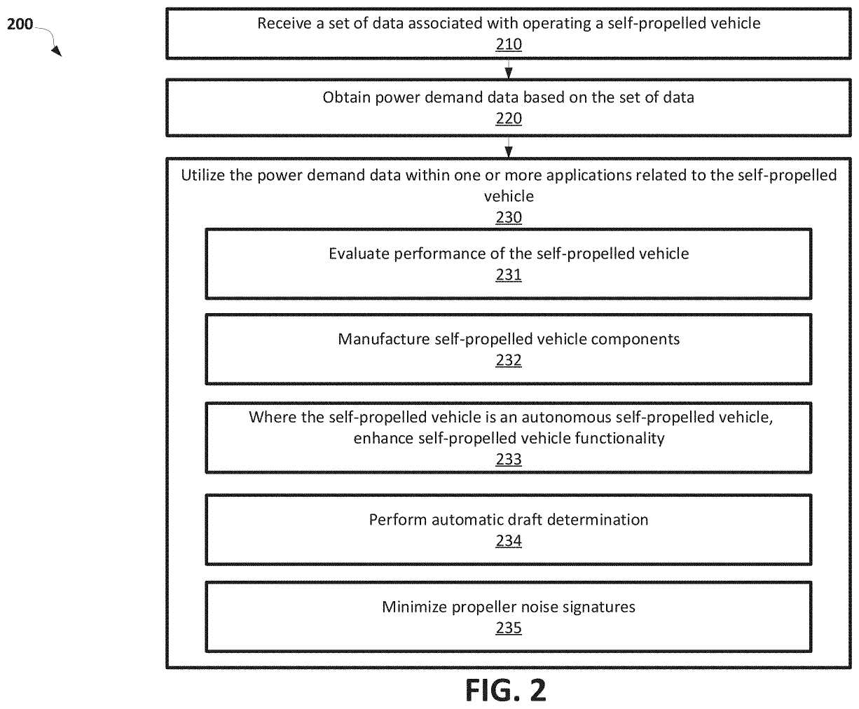

In some implementations, the client device 160 may include a power demand manager 161 that can obtain and utilize power demand prediction of a self-propelled vehicle (e.g., vessel). Power demand manager 161 may be an application that executes entirely on client device 160. In other implementations, power demand manager 161 may function in whole or in part on server device 140. In such instances, power demand manager 161 can function as a web-based or cloud-based application that is accessible to the user via a web browser or thin-client user interface that executes on client device 160. In some implementations, a portion of power demand manager 161 may execute on client device 160, and another portion of power demand manager 161 may execute on server device 140. While aspects of the present disclosure describe power demand manager 161 as implemented in a PaaS environment, it should be noted that in other implementations, power demand manager 161 can also be implemented in an Infrastructure-as-a-Service (IaaS) environment. The functionality of power demand manager 161 will now be described in further detail below with respect to FIG. 2.

FIG. 2 depicts a flow diagram of an example method 200 for obtaining and utilizing a power demand of a self-propelled vehicle, in accordance with one or more aspects of the present disclosure. The method may be performed by processing logic that may comprise hardware (circuitry, dedicated logic, etc.), computer-readable instructions (run on a general-purpose computer system or a dedicated machine), or a combination of both. In an illustrative example, method 200 may be performed by a power demand manager, such as the power demand manager 161 in FIG. 1. Alternatively, some or all of method 200 might be performed by another module or machine. It should be noted that blocks depicted in FIG. 2 could be performed simultaneously or in a different order than that depicted.

At operation 210, the processing logic receives a set of data associated with operating a self-propelled vehicle and, at operation 220, the processing logic obtains power demand data based on the set of data.

In some embodiments, the self-propelled vehicle is a self-propelled vessel. For example, the self-propelled vessel can be a ship, boat, underwater vessel (e.g., submarine), etc. In some embodiments, the self-propelled vehicle is an autonomous or self-driving self-propelled vehicle (AV). For example, the self-propelled vehicle can be an underwater autonomous vessel (UAV). For the sake of illustration, the description of the method described in FIG. 2 will be provided in the context of a self-propelled vessel. However, it should be understood and appreciated that the description of FIG. 2 can be extended to any other type of self-propelled vehicle in accordance with the embodiments described herein (e.g., aerial vehicle).

For example, the set of data received at operation 210 can be based on the open-water performance of a propeller. More specifically, the propeller refers to a scaled-model propeller tested in a towing tank. The propeller during open-water testing can be powered from a carriage through a streamlined housing, and can be pushed along the towing tank with the propeller ahead of the housing so that the propeller is effectively in undisturbed water. Records of propeller thrust (T) developed by the propeller in the direction of the shaft and torque (Q) delivered to the propeller can be taken for a range of propeller advance speeds (V_{A}) and propeller revolutions (n). Such tests can eliminate cavitation inception and provide data of the propeller in uniform flow. The thrust (T) and torque (Q) that are recorded during the tests can be non-dimensionalized by applying the following equations (1) and (2):

$$\begin{matrix}{K}_{T} = \frac{T}{ρ \cdot {n}^{2} \cdot {D}^{4}} & ( 1 ) \\ {K}_{Q} = \frac{Q}{ρ \cdot {n}^{2} \cdot {D}^{5}} & ( 2 )\end{matrix}$$

where D is the diameter of the propeller, p is the mass density of the fluid (e.g., water), n is the rate of rotation, K_{T} is a thrust coefficient corresponding to the thrust (T) produced by the open-water propeller, and K_{Q} is a torque coefficient corresponding to the torque (Q) delivered to the open-water propeller. Open water performance of the propeller can then be computed using equation (3):

$${η}_{o} = \frac{J \cdot {K}_{T}}{2 π \cdot {K}_{Q}} \qquad ( 3 )$$

Where ηₒ is the efficiency of the open-water propeller, J is a propeller advance coefficient or parameter relating the propeller advance speed (V_{A}) to the rate of rotation (n). For example, J=V_{A}/nD.

Now, define K_{To} as a zero-speed thrust coefficient and K_{Qo} K_{To}K_{Qo} as a zero-speed torque coefficient. More specifically, K_{To} is the thrust coefficient K_{T} when the value of the propeller advance ratio J is zero (K_{To}=K_{T}(J=0)), and K_{Qo} is the torque coefficient K_{Q} when the value of the propeller advance ratio J is zero (K_{Qo}=K_{Q}(J=0)). We can further define coefficients Jₒₜ and J_{oq} as a zero-thrust propeller advance ratio and a zero-torque propeller advance ratio, respectively. More specifically, Jₒₜ is the propeller advance ratio J such that the thrust developed by the propeller is zero (Jₒₜ=J(K_{T}=0)), and J_{oq} is the propeller advance ratio J such that the torque delivered to the propeller is zero (J_{oq}=J(K_{Q}=0)).

The simplest approximations of an arbitrary K_{Q} curve could be a straight line connecting the point (J_{oq}, 0) with the point (0, K_{Qo}). For example, it can be assumed that the propeller advance ratio (J) is the simplest possible Taylor Series expansion of an unknown underlying function, f(J), such that:

$${K}_{Q} = {K}_{Q o} \cdot ( 1 - \frac{f ( J )}{f ( {J}_{o q} )} ) \qquad ( 4 )$$

$$and$$

$$\begin{matrix}{K}_{Q} = {K}_{Q o} \cdot ( 1 - \frac{f ( a ) + \frac{{f}^{′} ( a )}{1 !} ( J - a ) + \frac{{f}^{″} ( a )}{2 !} {( J - a )}^{2} + …}{f ( a ) + \frac{{f}^{′} ( a )}{1 !} ( {J}_{o q} - a ) + \frac{{f}^{″} ( a )}{2 !} {( {J}_{o q} - a )}^{2} + …} ) \\ \approx {K}_{Q o} \cdot ( 1 - \frac{J}{{J}_{o q}} )\end{matrix} \qquad ( 5 )$$

From equation (5), it is apparent that a=0 and f(0)=0. Moreover, any torque curvature parameter k_{q} satisfying f′(0)=k_{q}·J would verify equation (5). Equation (4) can be rewritten as:

$${K}_{Q} = {K}_{Q o} - \frac{{K}_{Q o}}{f ( {J}_{o q} )} f ( J ) \qquad ( 6 )$$

such that the first, second and third derivatives of K_{Q} with respect to J are as follows:

$$\frac{d {K}_{Q}}{dJ} = - \frac{{K}_{Q o}}{f ( {J}_{o q} )} \frac{d}{dJ} f ( J ) \qquad ( 7 )$$

$$\frac{{d}^{2} {K}_{Q}}{{dJ}^{2}} = - \frac{{K}_{Q o}}{f ( {J}_{o q} )} \frac{{d}^{2}}{{dJ}^{2}} f ( J ) \qquad ( 8 )$$

$$\frac{{d}^{3} {K}_{Q}}{{dJ}^{3}} = - \frac{{K}_{Q o}}{f ( {J}_{o q} )} \frac{{d}^{3}}{{dJ}^{3}} f ( J ) \qquad ( 9 )$$

A reasonable assumption for an expression characterizing the torque (Q) is that Q is smooth (i.e., infinitely derivable), thereby preventing

$$\frac{{d}^{3} {K}_{Q}}{{dJ}^{3}}$$

from being equal to a constant value. Thus, the simplest approximation for

$$\frac{{d}^{3} {K}_{Q}}{{dJ}^{3}}$$

is that of linear dependency with the propeller advance ratio (J), as shown in equation (10):

$$\frac{{d}^{3} {K}_{Q}}{{dJ}^{3}} \approx {c}_{1} \cdot J + {c}_{2} \qquad ( 10 )$$

where c₁ and c₂ are constants. Solving for K_{Q} by integrating equation (10) yields:

$${K}_{Q} = {c}_{3} {e}^{{c}_{1}^{1 / 3} J} + {c}_{4} {e}^{{( - 1 )}^{2 / 3} {c}_{1}^{1 / 3} J} + {c}_{5} {e}^{- {( - 1 )}^{1 / 3} {c}_{1}^{1 / 3} J} - \frac{{c}_{2}}{{c}_{1}} \qquad ( 11 )$$

where c₃, c₄ and c₅ are constants. Combining equation (11) with equation (4):

$${K}_{Q o} \cdot ( 1 - \frac{f ( J )}{f ( {J}_{o q} )} ) = {c}_{3} {e}^{{c}_{1}^{1 / 3} J} + {c}_{4} {e}^{{( - 1 )}^{2 / 3} {c}_{1}^{1 / 3} J} + {c}_{5} {e}^{- {( - 1 )}^{1 / 3} {c}_{1}^{1 / 3} J} - \frac{{c}_{2}}{{c}_{1}} \qquad ( 12 )$$

To satisfy equation (12), the following holds:

$${c}_{4} = {c}_{5} = 0 ; \qquad ( 1 )$$

$${k}_{q} = {c}_{1}^{1 / 3} ; \qquad ( 2 )$$

$${K}_{Q o} = {c}_{3} + \frac{{c}_{2}}{{c}_{1}} ; and \qquad ( 3 )$$

$${J}_{o q} = \frac{1}{{k}_{q}} \cdot ln ( - \frac{{c}_{2}}{{c}_{1} \cdot {c}_{3}} ) , \qquad ( 4 )$$

f(J) can be expressed by the following exponential function:

f(J)=e^{k}^{_{q}}^{·J}−1 (13)

and equation (4) can be written as:

$${K}_{Q} = {K}_{Q o} \cdot ( 1 - \frac{{e}^{{k}_{q} \cdot J} - 1}{{e}^{{k}_{q} \cdot {J}_{oq}} - 1} ) \qquad ( 14 )$$

Similarly, the thrust coefficient (K_{T}) can be represented by the following expression:

$${K}_{T} = {K}_{To} \cdot ( 1 - \frac{{e}^{{k}_{t} \cdot J} - 1}{{e}^{{k}_{t} \cdot {J}_{ot}} - 1} ) \qquad ( 15 )$$

where kₜ is a thrust curvature parameter. In view of equations (7) and (8), the efficiency of the open-water propeller (ηₒ) from equation (3) can be expressed as:

$${η}_{o} = \frac{J}{2 π} \cdot \frac{{K}_{T o}}{{K}_{Q o}} \cdot \frac{( {e}^{{k}_{q} \cdot {J}_{o q}} - 1 )}{( {e}^{{k}_{t} \cdot {J}_{ot}} - 1 )} \cdot \frac{( {e}^{{k}_{t} \cdot {J}_{ot}} - {e}^{{k}_{t} \cdot J} )}{( {e}^{{k}_{q} \cdot {J}_{oq}} - {e}^{{k}_{q} \cdot J )}} \qquad ( 16 )$$

An analytical derivation of the curvature parameters k_{q} and kₜ from the geometric properties of the propeller is not presented here. However, these curvature parameters can be obtained through regression analysis of experimental data. The following is a table of exemplary values of J, K_{T} and K_{Q} obtained for an open water propeller:

TABLE 1

| J | K_{T} | K_{Q} |
|---|---|---|
| 0 | 0.4570 | 0.06990 |
| 0.1 | 0.4286 | 0.06626 |
| 0.2 | 0.3990 | 0.06275 |
| 0.3 | 0.3662 | 0.05865 |
| 0.4 | 0.3326 | 0.05392 |
| 0.5 | 0.2958 | 0.04885 |
| 0.6 | 0.2596 | 0.04360 |
| 0.7 | 0.2203 | 0.03779 |
| 0.8 | 0.1790 | 0.03198 |
| 0.9 | 0.1348 | 0.02548 |
| 1.0 | 0.0889 | 0.01841 |
| 1.1 | 0.0413 | 0.01100 |

Applying equations (14)-(16) to the open-water propeller data listed in Table 1 leads to the following equations (17)-(19) with the goodness-of-fit shown by each respective determination coefficient:

$${K}_{Q}^{*} = 0.07 \cdot ( 1 - \frac{{e}^{0.73 \cdot J} - 1}{{e}^{0.73 \cdot 1.23} - 1} ) \qquad ( 17 )$$

$${R}^{2} = 0.9 \; 9992$$

$${K}_{T}^{*} = 0.4575 \cdot ( 1 - \frac{{e}^{0.51 \cdot J} - 1}{{e}^{0.51 \cdot 1.18} - 1} ) \qquad ( 18 )$$

$${R}^{2} = 0.9 \; 9999$$

$${η}_{o}^{*} = \frac{J}{2 π} \cdot \frac{0.4575}{0.070} \cdot \frac{( {e}^{0.73 \cdot 1.23} - 1 )}{( {e}^{0.51 \cdot 1.18} - 1 )} \cdot \frac{( {e}^{0.51 \cdot 1.18} - {e}^{0.51 \cdot J} )}{( {e}^{0.73 \cdot 1.23} - {e}^{073 \cdot J} )} \qquad ( 19 )$$

$${R}^{2} = 0.99995$$

The following table includes the values of Table 1, with two additional columns that include the results of equations (17) and (18):

TABLE 2

| J | K_{T} | K_{Q} | K_{T}* | K_{Q}* |
|---|---|---|---|---|
| 0 | 0.4570 | 0.0699 | 0.457500 | 0.070000 |
| 0.1 | 0.4286 | 0.06626 | 0.428499 | 0.066355 |
| 0.2 | 0.3990 | 0.06275 | 0.397980 | 0.062434 |
| 0.3 | 0.3662 | 0.05865 | 0.365864 | 0.058217 |
| 0.4 | 0.3326 | 0.05392 | 0.332068 | 0.053680 |
| 0.5 | 0.2958 | 0.04885 | 0.296504 | 0.048799 |
| 0.6 | 0.2596 | 0.04360 | 0.259079 | 0.043548 |
| 0.7 | 0.2203 | 0.03779 | 0.219696 | 0.037900 |
| 0.8 | 0.1790 | 0.03198 | 0.178252 | 0.031825 |
| 0.9 | 0.1348 | 0.02548 | 0.134640 | 0.025289 |
| 1.0 | 0.0889 | 0.01841 | 0.088745 | 0.018258 |
| 1.1 | 0.0413 | 0.01100 | 0.040450 | 0.010695 |

Now, we move from the open water scenario to the full-scale vessel scenario. The effect of moving the propeller from the open-water scenario to a behind-the-hull scenario is typically quantified through the inclusion of a wake fraction coefficient (w), a thrust deduction coefficient (t), and a rotative relative efficiency (η_{R}).

The wake fraction coefficient (w) accounts for the loss of speed of the water relative to the hull at the propeller position. The wake is the combination of the boundary layer associated with skin friction, the flow velocities occasioned by the streamlined form of the ship and the orbital velocities of the waves created by the ship. If the ship's speed is V and the speed of advance (e.g., the average velocity of the water relative to the hull at the propeller position) is V_{A}, then the non-dimensional wake fraction coefficient can be defined as follows:

$$w = \frac{V - {V}_{A}}{V} \qquad ( 20 )$$

where V−V_{A} is the wake speed.

The action of the propeller causes the water in front of it to be sucked towards the propeller. This can result in extra resistance on the hull. Thus, the thrust force T on the propeller must overcome both the ship's towing resistance (R_{T}) and the extra resistance on the hull due to the sucking action of the propeller. The difference between the thrust force T and the towing resistance R_{T}, T−R_{T}, corresponds to a loss of thrust. A non-dimensional thrust deduction coefficient (t) can be defined as follows:

$$t = \frac{T - {R}_{T}}{T} \qquad ( 21 )$$

From equation (14), it is apparent that R_{T}=T(1−t).

Since water closes in around the stern, the flow through the propeller disc will not be everywhere the same and will not, in general, be parallel to the shaft line. These effects can be combined and expressed as a relative rotative efficiency (η_{R}), which can be defined as follows:

$${η}_{R} = \frac{{η}_{B}}{{η}_{o}} \qquad ( 22 )$$

where η_{B} is the behind-the-hull propeller efficiency and ηₒ is the open water propeller efficiency.

η_{B} is the ratio between the thrust power (P_{T}) and the delivered power (P_{D}) when the propeller is in operation behind-the-hull. More specifically, P_{T} is the power developed by the thrust of the propeller at the speed of advance (P_{T}=TV_{A}), and P_{D} is the power delivered to (or absorbed by) the propeller when operating behind the hull (P_{D}=2πnQ=2πpn³D⁵K_{Q}). Thus, η_{B}=P_{T}/P_{D}=TV_{A}/(2πQn). ηₒ is the ratio between P_{T} and P_{D} when operating in open water with uniform inflow velocity V_{A}. For example, ηₒ=T·V_{A}/(2πQₒn).

A shaft power demand (P_{S}) measured in the shaft and delivered to the shafting system by the propelling machinery can be defined as:

$${P}_{S} = \frac{{P}_{D}}{{η}_{S}} = \frac{1}{{η}_{S} {η}_{R}} \cdot 2 \cdot π \cdot ρ \cdot {n}^{3} \cdot {D}^{5} \cdot {K}_{Q} ( \frac{( 1 - w ) \cdot V}{n D} ) \qquad ( 23 )$$

where ηₛ is a shafting efficiency. The shafting efficiency ηₛ can be a measure of the power lost in shaft bearings and a stern tube. For example, η_{S}=P_{D}/P_{S}. Moreover, an effective power demand (P_{E}) needed to tow a ship at a constant speed V in unlimited undisturbed water (e.g., without its propulsive device) can be defined as:

$${P}_{E} = ( 1 - t ) \cdot p \cdot {n}^{2} \cdot {D}^{4} \cdot V \cdot {K}_{T} ( \frac{( 1 - w ) \cdot V}{n \cdot D} ) \qquad ( 24 )$$

In view of equations (14) and (15) above providing an expression for K_{Q} and K_{T} respectively, P_{S} can be expressed in equation (25) as follows:

$${P}_{S} = \frac{1}{{η}_{s} \cdot {η}_{R}} \cdot 2 \cdot π \cdot ρ \cdot {n}^{3} \cdot {D}^{5} \cdot {K}_{Q o} \cdot ( \frac{{e}^{{k}_{q} \cdot {J}_{o q}} - {e}^{{{k}_{q} \cdot \frac{( 1 - w ) \cdot V}{n \cdot D}}_{}}}{{e}^{{k}_{q} \cdot {J}_{oq}} - 1} ) \qquad ( 25 )$$

and P_{E} can be expressed in equation (26) as follows:

$${P}_{E} = ( 1 - t ) \cdot ρ \cdot {D}^{4} \cdot V \cdot {n}^{2} \cdot {K}_{T o} \cdot ( \frac{{e}^{{k}_{t} \cdot {J}_{o t}} - {e}^{{{k}_{t} \cdot \frac{( 1 - w ) \cdot V}{n \cdot D}}_{}}}{{e}^{{k}_{t} \cdot {J}_{o t}} - 1} ) \qquad ( 26 )$$

In view of the above, the power demand data obtained at operation 220 can include the shaft power demand (P_{S}) and/or the effective power demand (P_{E}). Equations (25) and (26) are approximations of unknown exact expressions. However, these approximations can predict P_{S} and P_{E} of a self-propelled vessel moving under arbitrary operational conditions with higher accuracy than other measurement systems that collect data relevant to power demand.

At operation 230, the processing logic utilizes the power demand data within one or more applications related to the self-propelled vehicle. The one or more applications can improve one or more aspects related to the self-propelled vehicle.

In some embodiments, utilizing the power demand data includes, at operation 231, evaluating the performance of the self-propelled vehicle based on the power demand data. Vessel performance evaluation attempts to quantify the speed reduction or increase of the power demand that results from in-service deterioration of the self-propelled vehicle.

Equation (25) above, which is used to determine the shaft power demand (P_{S}), assumes that the open-water characteristics of the propeller are known. However, knowledge of the open-water characteristics may not always be possible. Also, even though the wake fraction coefficient and the relative rotative efficiency depend on vessel speed, draft, trim, turbulence intensity field and other parameters, the progressive increase of drag due to, for example, biological fouling (“biofouling”) can have a global effect of them. Biofouling refers to the accumulation or deposition of biological material (e.g., algae, plants, microorganisms, animals, etc.), leading to degradation and/or reduced performance. Thus, capturing the time evolution of the average relative rotative efficiency (η̅_̅{̅R̅}̅) and the average wake fraction (w̅) makes it possible to quantify drag increase over time accurately. In practicality, it can be convenient to rewrite equation (25) as:

$${P}_{S} = ξ \cdot {n}^{3} \cdot {e}^{- 3 ζ \frac{V}{n}} = ξ \cdot {n}^{3} \cdot {( {e}^{- ζ \frac{V}{n}} )}^{3} \qquad ( 27 )$$

where ξ and ζ are parameters that can be defined as follows:

$$ξ \approx \frac{1}{{η}_{s} \cdot \overline{{η}_{R}}} \cdot 2 \cdot π \cdot ρ \cdot {D}^{5} \cdot {K}_{Q o} \qquad ( 28 )$$

$$ζ \approx - \frac{1}{3} \frac{n}{V} \cdot log ( \frac{1 - {e}^{- {k}_{q} ( {J}_{o q} - \frac{( 1 - \overline{w} ) \cdot V}{n \cdot D} )}}{1 - {e}^{- {k}_{q} \cdot Joq}} ) \qquad ( 29 )$$

Equation (27) can be directly regressed over operational data in place of equation (25). Equation (27) can be further simplified, with a negligible loss of accuracy, as follows:

$${P}_{s} = ξ \cdot {n}^{3} \cdot {( 1 - ζ \cdot \frac{V}{n} )}^{3} = ξ \cdot {( n - ζ \cdot V )}^{3} \qquad ( 30 )$$

which can be rewritten as:

$${P}_{S}^{\frac{1}{3}} = {ξ}^{\frac{1}{3}} \cdot n - {ξ}^{\frac{1}{3}} \cdot ζ \cdot V \qquad ( 31 )$$

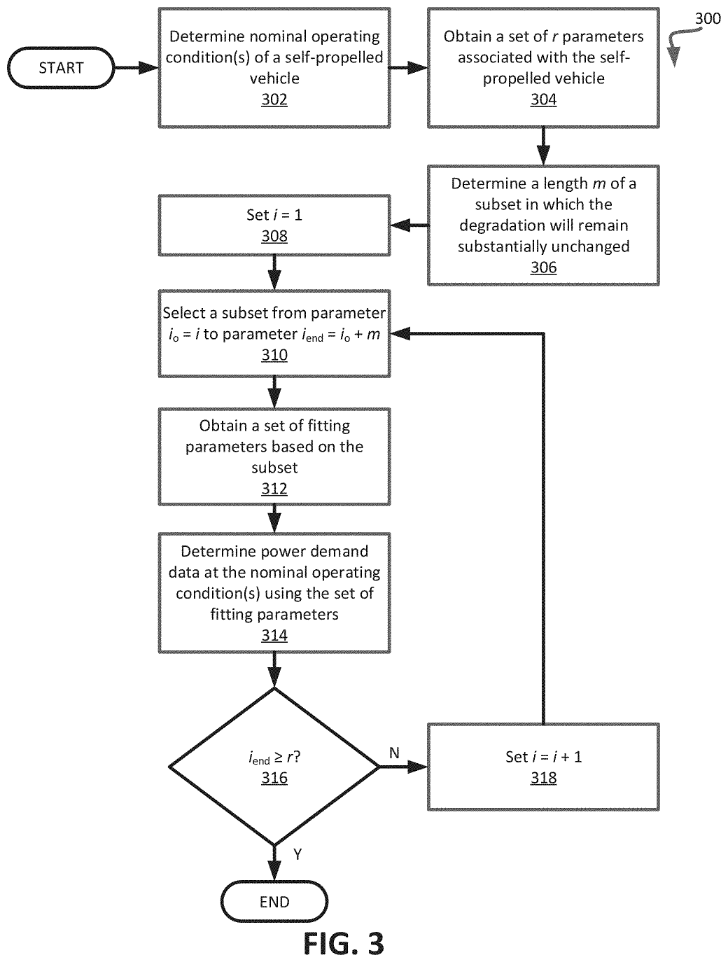

Equation (31) enables the application of a linear regression analysis, which represents a significant benefit in terms of numerical stability, especially when working over challenging datasets. Then, given a time series of operational vessel sailing data, a series of (ξ, ζ)ᵢ values can be obtained by iteratively applying regression analysis over a moving window of data along the time series. The evolution of the values (ξ, ζ)ᵢ can capture the average degradation of the values (η_{R}, w)ᵢ over time. Given pre-defined nominal operating conditions (nₒ, Vₒ), if for each pair (ξ, ζ)ᵢ the vessel power demand at (nₒ, Vₒ) is then calculated, the evolution over time of the vessel power demand as if the vessel would continuously sail at nominal conditions can be obtained, thus accurately reflecting the time evolution of vessel performance. The process finalizes when the moving window m arrives to the end of the dataset. At that point, we have calculated the shaft power demand of the vessel as if the vessel would have continuously sailed at the fixed conditions, thus reflecting changes in the degradation. A flow chart depicting the evaluation of the performance of a self-propelled vessel using this method will now be described below with reference to FIG. 3.

FIG. 3 is a flow diagram of an example method 300 for evaluating the performance of a self-propelled vessel based on power demand data. For example, the method 300 can be used to quantify the evolution of degradation of a vehicle (e.g., degradation of the hull of a vessel) over time. The method may be performed by processing logic that may comprise hardware (circuitry, dedicated logic, etc.), computer-readable instructions (run on a general-purpose computer system or a dedicated machine), or a combination of both. In an illustrative example, method 300 may be performed by a power demand manager, such as the power demand manager 161 in FIG. 1. Alternatively, some or all of method 300 might be performed by another module or machine. It should be noted that blocks depicted in FIG. 3 could be performed simultaneously or in a different order than that depicted.

At operation 302, the processing logic determines one or more nominal operating conditions of a self-propelled vehicle. In some embodiments, the nominal operating condition(s) are nominal sailing conditions associated with a self-propelled vessel. For example, the nominal operating conditions can include a nominal ship speed at design or other pre-defined chosen fixed condition (Vₒ) and/or a nominal propeller rotation rate at design or otherwise pre-defined chosen fixed condition (nₒ).

At operation 304, the processing logic obtains a set of r parameters associated with the self-propelled vehicle. In some embodiments, the set of r parameters are associated with a self-propelled vessel. For example, the set of r parameters can include shaft power (P_{S}), vessel speed (V), propeller rotation rate (n), etc.

At operation 306, the processing logic determines a length m of a subset in which degradation will remain substantially unchanged. More specifically, m corresponds to a moving window of data over m number of days, such that the data includes variability in terms of conditions (e.g., speed, draft, weather), but that the conditions in terms of fouling, performance, etc. remain substantially unchanged. For example, m can be equal to 30.

At operation 308, the processing logic initializes a parameter counter i by setting i=1. At operation 310, the processing logic selects a subset from parameter iₒ=i to parameter i_{end}=iₒ+m. At operation 312, the processing logic obtains a set of fitting parameters based on the subset. In some embodiments, obtaining the set of fitting parameters includes performing a regression analysis. For example, the set of fitting parameters can include i-th fitting parameters, ξᵢ and ζᵢ, obtained by regressing a (simplified) shaft power demand equation over operational data (e.g., based on Equations (28) and (29)).

At operation 314, the processing logic determines power demand data at the nominal operating condition(s) using the set of fitting parameters. For example, determining the power demand data can include determining an i-th shaft power at the nominal operating condition(s) (P_{o,i}) using the set of fitting parameters.

At operation 316, the processing logic determines whether i_{end}≥r. If so, this means that there are no more parameters left for determining power demand data, and the process ends. Otherwise, the processing logic, at operation 318, updates the parameter counter i by setting i=i+1, and the process reverts back to operation 310 for the processing logic to take another subset from parameter iₒ=i+1 to parameter i_{end}=iₒ+m.

The method 300 can be used to quantify the evolution of degradation of a vehicle over time. For example, the method 300 can be used to quantify the evolution of degradation of a hull of a vessel over time. As an illustrative example, for the sake of simplicity, consider a synthetic dataset of 365 data points (each point corresponding to a day of the year). A variable “DayNumber” can be defined as an incremental counter between 1 and 365. For this illustrative example, it will be assumed that the vessel speed, expressed in knots, changes daily following the equation:

$${V}_{s y n t h} = ⌊ 18.5 + ( \frac{7}{π} \cdot arcsin ( sin ( \frac{20 π}{9} \cdot DayNumber ) ) ) ⌋ \qquad ( 32 )$$

and the draft (Draft_{synth}), in percent displacement, changes weekly following the equation:

$${Draft}_{s y n t h} = 60 + 40 \cdot ( WeekNumber - 2 ⌊ \frac{W e e k N u m b e r}{2} ⌋ ) = 60 + 40 \cdot ( WeekNumber mod 2 ) \qquad ( 33 )$$

where the variable “WeekNumber” is calculated as:

$$WeekNumber = 1 + ⌊ \frac{D a y N u m b e r}{7} ⌋ \qquad ( 34 )$$

As noted by the following table, equation (34) provides two values, namely 60 when the WeekNumber is even and 100 when the WeekNumber is odd:

TABLE 3

| | | 60 + 40 · |
|---|---|---|
| WeekNumber | WeekNumber mod 2 | (WeekNumber mod 2) |
| 1 | 1 | 100 |
| 2 | 0 | 60 |
| 3 | 1 | 100 |
| 4 | 0 | 60 |

The values of propeller revolutions, wake fraction, relative rotative efficiency and shaft power demand can be taken by matching the speed and draft synthetic values to the synthetic data. The resulting power demand can be multiplied by a biofouling coefficient (starting at a value of 1) that increases over time (e.g., linearly) to simulate the progressive increase in power needed to overcome biofouling. If the vessel is cleaned to address biofouling during the 365 day period, the biofouling coefficient can drop back to a value of 1 before increasing over time once more. For example, if the vessel begins operation on January 1 having a biofouling coefficient with a value of 1 and rises to a value of 1.02 by June 30, the vessel can be cleaned at the half year mark on July 1 such that the biofouling coefficient drops back down to 1.

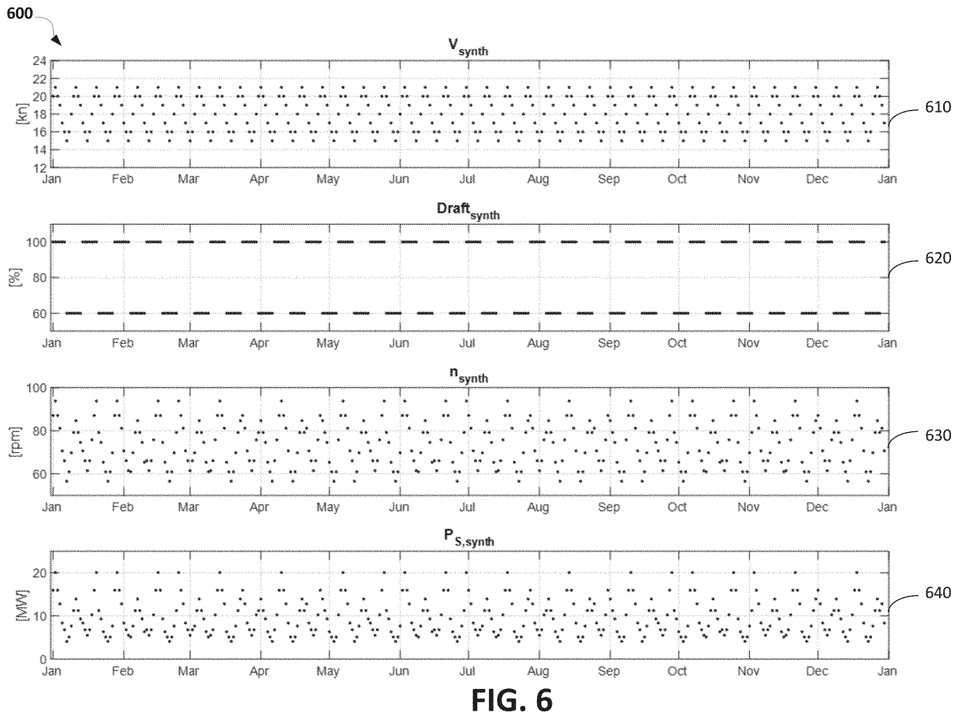

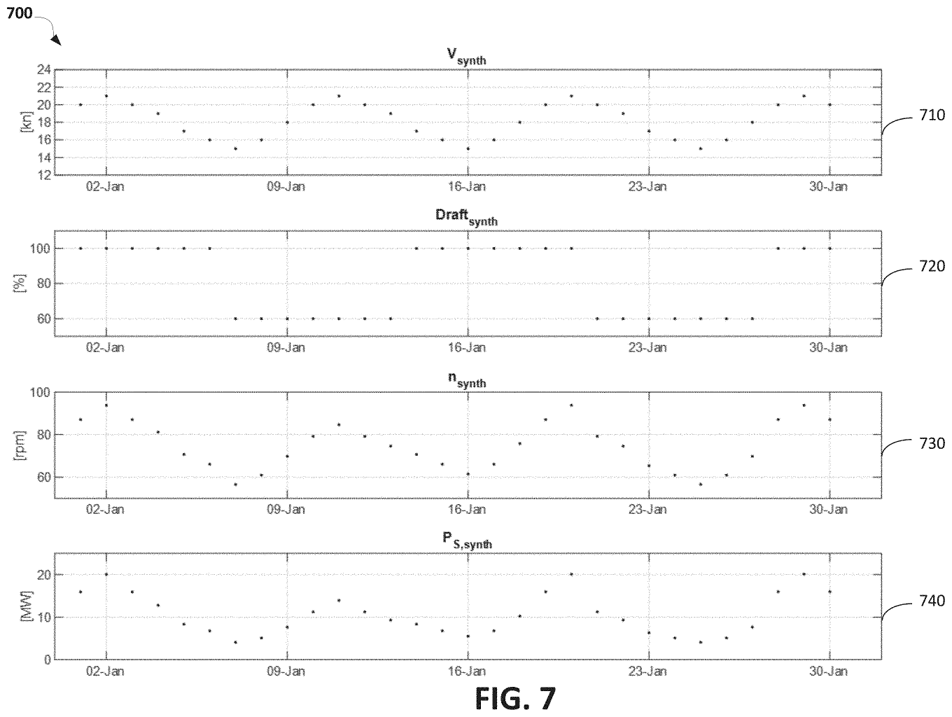

For the sake of illustration, assume that synthetic data 600 is obtained and plotted over a year period as shown in FIG. 6. More specifically, the synthetic data 600 includes a synthetic speed (V_{synth}) graph 610, a synthetic draft (Draft_{synth}) graph 620, synthetic rate of rotation (n_{synth}) graph 630, and a synthetic shaft power demand graph (P_{S,synth}) 640. A moving window m having a size of 30 days can be defined, and the nominal sailing conditions of the vessel can be set as Vₒ=20 knots and nₒ=80 rpm. An example of synthetic data extracted from the synthetic data 600 over a first 30 day window between January 1 and January 30 is provided with reference to the synthetic data 700 of FIG. 7. More specifically, the synthetic data 700 includes V_{synth} graph 710, Draft_{synth} graph 720, n_{synth} graph 730, and P_{S,synth} graph 740.

The first step is to take data within the first 30 day window. Then, using regression analysis, we can fit equation (25) to the data selection over the first 30 day window shown in FIG. 7 to obtain parameters η̅_̅{̅R̅}̅ and w̅ and/or equation (30) to the data selection over the first 30 day window shown in FIG. 7 to obtain ξ and ζ. The relative rotative efficiency parameter η̅_̅{̅R̅}̅ can have values exceeding 1. The fitting parameters can be used to calculate the shaft power demand at the selected nominal sailing conditions

$${V}_{o} = 20 knots = 20 \frac{n m}{h} \cdot \frac{1852 m}{1 nm} \cdot \frac{1 h}{3600 sec} = 20 \cdot 0.5144 \frac{m}{s} and \\ {n}_{o} = 80 rpm = \frac{80}{60} Hz ,$$

where nm refers to a nautical mile.

For example, if η̅_̅{̅R̅}̅=1.247 and w̅=0.467 are parameters obtained by regressing equation (25) over the first 30 day window, then:

$${P}_{S} = \frac{1}{{η}_{S} \cdot \overline{{η}_{R}}} \cdot 2 \cdot π \cdot ρ \cdot {n}_{o}^{3} \cdot {D}^{5} \cdot {K}_{Q o} \cdot ( 1 - \frac{{e}^{{{k}_{q} \frac{( 1 - \overline{w} ) {V}_{o}}{{n}_{o} D}}_{}} - 1}{{e}^{{k}_{q} {J}_{oq}} - 1} ) = \frac{1}{0.999 \cdot 1.247} \cdot 2 \cdot π \cdot 1025 \cdot {( \frac{80}{60} )}^{3} \cdot {7.315}^{5} \cdot 0.07 \cdot ( 1 - \frac{{e}^{0.73 \frac{( 1 - 0.467 ) \cdot 20 \cdot 0.5144}{1.333 \cdot 7.315}} - 1}{{e}^{0.73 \cdot 1.233} - 1} ) = 11.73 MW \qquad ( 35 )$$

where ηₛ=0.999, ρ=1025 kg/m³, and D=7.315 m are known operational values for shaft efficiency, water density and propeller diameter, respectively. Parameters K_{Qo}=0.070, J_{oq}=1.233 and k_{q}=0.730 can be obtained by regressing equation (14) over the open-water propeller data (i.e., these parameters are known as long as the open-water characteristics of the propeller are known). As another example, if ξ=8.511 and ζ=0.0214 are parameters obtained by regressing equation (30) over the first 30 day window, then:

P_{S}=8.511·(80/60−0.0214·20·0.5144)³=11.75 MW (36)

As shown, the values obtained in equation (35) and equation (36) differ by only 0.02 MW, which further shows that the simplified equation (30) can be a suitable approximation for equation (25).

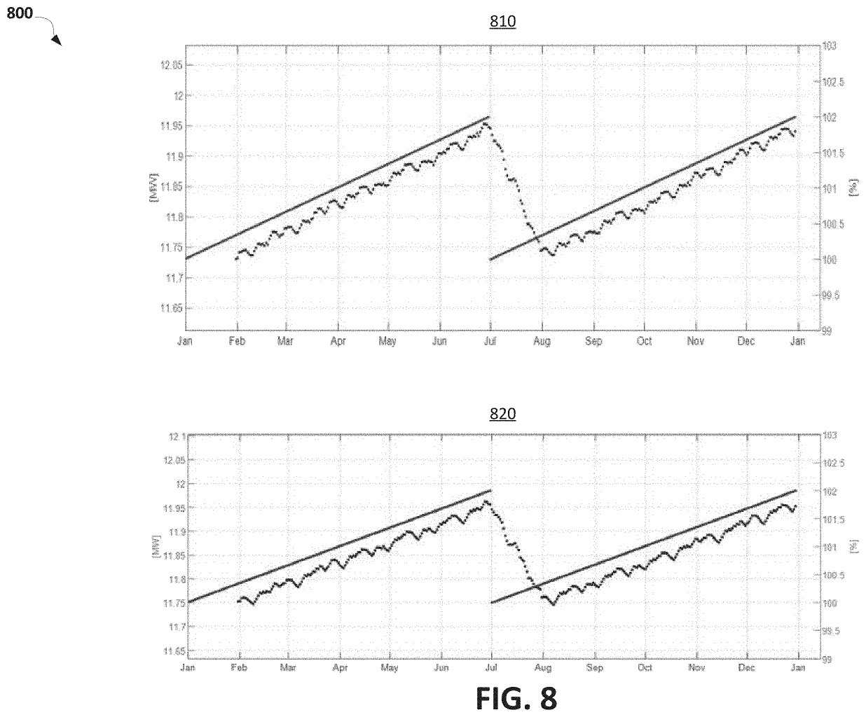

The moving window m can then be advanced by 1 day to obtain a second moving window from January 2-January 31, and the process can be repeated to take data from the second moving window. The process finalizes when the moving window m arrives at the end of the dataset. At that point, the shaft power demand, Pₛ, of the vessel has been calculated as if the vessel would have continuously sailed at the fixed conditions at Vₒ=20 knots and nₒ=80 rpm, thus reflecting changes in the degradation of the hull. For example, FIG. 8 shows a graph 810 corresponding to using equation (25) over the year period, and a graph 820 corresponding to using equation (30) over the year period. The graphs 810 and 820 can be used to identify, e.g., a hull cleaning event that occurred on July 1, the maximum increase in Pₛ, and the hull degradation rate.

Referring back to FIG. 2, the successful application of the vessel performance evaluation method at operation 231 described over operational sailing data collected with electronic data loggers or similar automatic systems is straightforward. However, the vessel performance evaluation method over operational sailing data directly reported by the Captain and Chief Engineer, by means of what is commonly known as Noon Reports, may require further consideration. Noon Reports are usually referred to as a vessel data collection system in which the captain submits a daily report detailing the fuel consumption, average power demand, and other relevant parameters that reflect the ship's operational profile over the previous 24 hours. The uncertainty related to the manual entry round-off error in these reports is commonly accepted as an impassable barrier to perform any meaningful performance analysis. However, it can be shown that the source of error in the Noon Reports data relies on the loss of information sustained by submitting simple averages as aggregated measures of vessel speed and propeller revolutions. One way to successfully apply this vessel performance evaluation method over the vessel data collection system is by extending the reports to include instantaneous values of the relevant metrics. If this remedial measure is not feasible, a meaningful vessel performance evaluation analysis could still be conducted by deriving the coefficient ξ from the open-water characteristics of the propeller, and then iteratively applying regression analysis, obtaining just ζᵢ as the fitting parameter.

In some embodiments, utilizing the power demand data includes, at operation 232, manufacturing self-propelled vehicle components. For example, equation (16), combined with operational data of shaft power demand, vessel speed and propeller revolutions, as well as the open water characteristics of the propeller, allow accurate estimations of the wake coefficient and rotative relative efficiency to be obtained for a wide variability range of operational conditions. Having an accurate estimation of the operational profile of the full-scale vessel during early design stages using the power demand data can, for example: (1) enable optimal vessel design; (2) reduce design cycle workload by minimizing computational fluid dynamics (CFD) and towing tank testing; (3) optimize propeller design according to target mission (e.g., efficiency, stealth, mobility); (4) enable rapid exploration of customized propeller designs both in the scopes of generic propellers as well as experimental designs and/or add-ons; (5) develop new concept experimental designs optimized for a desired target metric; and (6) develop accurate propulsion models in conjunction with vehicle dynamics (e.g., maneuvering and seakeeping).

Closed-form mathematical expressions, given relevant vessel parameters, that can find the propeller advance ratio that maximizes the propeller efficiency and/or the optimum diameter or revolutions per minute (RPM) of a given propeller can be obtained, e.g., from Equations (14)-(16). Moreover, to enable the validation of numerous towing resistance (R_{T}) approximation methods, equation (26) can be rewritten as:

$${R}_{T} = ( 1 - t ) \cdot ρ \cdot {D}^{4} \cdot {n}^{2} \cdot {K}_{T o} \cdot ( \frac{{e}^{{k}_{t} \cdot {J}_{o t}} - {e}^{{k}_{t} \cdot \frac{( 1 - w ) \cdot V}{n \cdot D}}}{{e}^{{k}_{t} \cdot {J}_{o t}} - 1} ) \qquad ( 36 )$$

In some embodiments, utilizing the power demand data includes, at operation 233, enhancing self-propelled vehicle functionality, where the self-propelled vehicle is an autonomous self-propelled vehicle (AV). The demand for AV's for, e.g., military and civil missions has greatly increased because of their performance in battle and rescue operations, and due to cost savings over human-operated vehicles. The accurate prediction of power demand during operation, as described herein, can enable the implementation of a decision-making algorithm and planning software that can recommend AV mission plans satisfying operator-defined mission goals and priorities.

For example, enhancing self-propelled vehicle functionality can include optimizing energy usage of the AV based on the power demand data. Joint path plans and sensor usage schedules can be generated that optimize energy usage efficiency over an entire mission. The advent of advanced sensing payloads and the interest in extending the operational lifetime of AV's necessitate the development of advanced, dynamic, AV mission-planning tools that go beyond path-planning optimization and “static” mission objectives alone. Conventional AV mission planning tools available today rely on models that quantify sensor coverage and energy consumption to define a “static” mission plan prior to starting the mission. Static mission plans often pre-define the power budget for the AV and its payloads to guarantee an ample energy reserve for AV emergency procedures. Missions are, however, dynamic in nature, and the corresponding mission plans should be reevaluated and optimized on-board the AV during mission execution. The embodiments described herein can be used within an autonomous operating system to optimize AV mission plans based on prioritized objectives with respect to path plans, sensor usage, and energy consumption while ensuring that prioritized mission objectives continue to be satisfied. The processing logic can dynamically reconfigure routing and sensor-usage scheduling processes to maximize AV mission effectiveness by efficiently using the available energy. Accordingly, expected energy-usage efficiency improvements and their impact on AV mission execution (e.g., duration and increased sensor duty cycles) and AV configuration (e.g., reduced AV battery size) can be quantified.

As another example, enhancing self-propelled vehicle functionality can include enabling a passive navigation device. More specifically, the correspondence between a particular set of values of the underlying parameters of, e.g., equation (26) with the operational conditions can enable a passive navigation device that allows a AV to develop and maintain awareness of its location on the Earth's surface without requiring Global Positioning System (GPS) technology, and while meeting accuracy requirements (e.g., requirements for restricted piloting and coastal/open-water navigation). The passive navigation device can be a fully integrated system that interfaces with the AV by passing a stream of latitude, longitude, time, and confidence fields. The passive navigation device can take an input from an onboard inertial navigation system (INS) that provides a “dead reckoning” solution to previous fixes and that gives a ship's heading information. Dead reckoning refers to identifying the current position of a moving object by using a previously determined position, which can be used to estimate other kinematic quantities such as speed, heading direction, and course over an elapsed time.

AV passive navigation stands at the intersection of three needs: autonomous navigation, passive sensing, and mitigation of GPS vulnerability. Regarding autonomous navigation, an AV can determine its position on the Earth's surface to get to its destination while avoiding shoal waters, charted obstacles, prohibited areas, etc. By avoiding the use of signal transmission (e.g., surface search or navigation radar) that can be used to reveal the location of an AV, passive sensing enabled by passive navigation can allow for an AV to operate stealthily or silently. One example of an AV that can benefit from passive navigation is a military AV, which can use passive navigation to remain “invisible” to adversaries. Additionally, commercial AV's may also find that staying silent can help avoid being targeted by warships and/or pirates. Regarding mitigating GPS vulnerability, the GPS has become the primary means for navigation for most ocean-going vessels. However, this system is susceptible to interruption or spoofing, especially during times of war or hostility.

As yet another example, enhancing self-propelled vehicle functionality can include implementing simultaneous localization for underwater AV's (UAV's). Due to the cumulative error that an INS can experience over time, conventional UAVs can require regular surfacing to obtain GPS fixes, or the presence of acoustic localization beacons, to correct position drift. Such options can be unavailable in certain applications (e.g., deep-water and/or Intelligence, Surveillance, and Reconnaissance missions). Underwater Terrain Aided Navigation (TAN) methods have also demonstrated the ability to provide accurate navigation resets. However, such methods are limited as they may require accurate high-resolution reference bathymetry maps (e.g., underwater depth maps), which are not available for much of the Earth's sea floor.

In response to the presently limited navigation capability, the power demand data described herein can assist UAV navigation in GPS-denied environments. For example, the power demand data can enable the implementation of robust Simultaneous Localization and Mapping (SLAM) techniques for assisting the navigation of UAV's operating in such GPS-denied environments. SLAM broadly refers to the problem of jointly creating and updating a map of an unknown environment and estimating a system's position and pose within it. However, for many UAV-based SLAM applications, the ultimate goal is not to generate a map of the environment, but to take advantage of the process to reduce position error growth (e.g., improved velocity-over-ground estimates).

The correspondence between a particular set of values of the underlying parameters of, e.g., equation (25), and the operational conditions allows for the implementation of SLAM-based techniques for aiding a passive UAV navigation system during long-duration submerged missions to assist in managing position error drift. Increasing overall navigational accuracy during a GPS-denied mission beyond what can be achieved with just the standard Doppler Velocity Logger (DVL) aiding to the INS makes it feasible to reset what otherwise would be an unbounded position error growth.

As yet another example, enhancing self-propelled vehicle functionality can include controlling and optimizing the energy of AV's having a hybrid propulsion system. Hybrid propulsion systems provide an advantage over conventional petrol-powered vehicles in terms of energy efficiency, autonomy, and noise signature. Examples of a hybrid propulsion system can include an integration of two or more power units such as IC engine, motor-generator/battery, fuel cell, jet engine, and/or solar cell.

The accurate prediction of power demand described above can enable the implementation of an intelligent controller that can be applied to control and optimize the energy (e.g., minimize energy flow) of a hybrid propulsion system. The controller can also minimize the weight, optimize the energy efficiency of the hybrid propulsion system for all operation conditions, and optimize the energy consumption and regeneration between the power units such that the hybrid propulsion system can operate in the highest efficient condition.

As yet another example, enhancing self-propelled vehicle functionality can include implementing real-time turbulence recognition. Atmospheric turbulence is encountered to some degree on nearly every mission of an aircraft, and the disturbances caused are usually compensated for by the pilot and/or flight control system. Aircrafts are designed and built to withstand defined levels of turbulence based on planned missions and operating areas. Once built, aircrafts are required to operate within corresponding flight limitations that keep the aircraft within those specified levels of turbulence severity. Encountering atmospheric turbulence beyond the flight limits can lead to aircraft structural damage and, in extreme cases, loss of aircraft control. For manned platforms, the pilot determines the severity of the turbulence, based on experience and real-time platform behavior, and acts appropriately with both safety and mission objectives in mind. However, with the development and fielding of autonomous systems, this functionality can be performed by the vehicle management system using on-board sensor data.

The correspondence between a particular set of values of the underlying parameters of, e.g., equation (25) with the conditions in which the vehicle is operating can enable the implementation of a turbulence recognition tool that recognizes and quantifies the real-time turbulence levels being experienced by an AV. More specifically, the turbulence recognition tool can convert data measured on-board into quantified atmospheric turbulence levels which are appropriate to the host platform. The turbulence recognition tool can be integrated into existing vehicles with minimal physical configuration modifications when the vehicle management systems supply vehicle position, velocities, accelerations, and air/water data parameters (e.g., angle of attack, angle of sideslip, dynamic pressure, and static pressure). The turbulence recognition tool can also work on different vehicle configurations, including weights, loadings, and operating speeds. The level of turbulence output by the turbulence recognition tool can correlate the reported turbulence level with existing forecast products available in the maritime environment and manned aircraft standards. The turbulence recognition tool can output an account for specific vehicle characteristics to generate safety-critical turbulence classification and intensity information for the operators relevant to the platform the system is installed in.

In some embodiments, utilizing the power demand data includes, at operation 234, performing automatic draft determination. Conventional naval architectural experiments (e.g., inclining experiment and displacement check) can be conducted prior to ship delivery to the fleet. Conventional experimental methods can be hazardous and can require a manned small boat to collect draft readings at various locations (e.g., port and starboard, bow and stern) using a draft tube. Draft readings with draft tubes rely on personnel judgment due to reading the meniscus in the equipment that is not standardized between shipyards and may result in inconsistencies in draft readings. Accordingly, conventional, manual experimental methods are not objective or repeatable.

The correspondence between a particular set of values of the underlying parameters of, e.g., equation (25) and the operational conditions allows for the implementation of automatic draft determination to accurately determine a vessel's draft during these naval architectural experiments. The autonomous draft determination described herein can be operable in various weather conditions, independent of hull forms and draft marks, and can contribute to reducing lifecycle costs by leveraging technology and data analytics.

Automatic draft determination utilizing the power demand data described herein can be used by shipyards to standardize the process of taking draft readings during naval architectural experiments. It can also be more efficient, accurate, and safer than conventional methods of determining the draft of a vessel when conducting naval architectural experiments. For example, the automatic draft determination can reduce the number of people needed to perform the experiment, reduce the risk of experiment delay due to the weather conditions that prohibit the small boat from going in the water to measure drafts, and shorten the duration of the process in its entirety. Accordingly, automatic draft determination, by removing the need from performing readings using the small boat as described above, can streamline the draft determination process, thereby preventing delays to support on-time delivery of ships and submarines, increasing personnel safety, and reducing operational costs.

In some embodiments, utilizing the power demand data includes, at operation 235, minimizing propeller noise signatures. Accurate propeller source noise models can be used to estimate the acoustic impact of proposed propeller operations. However, conventional propeller source noise models used by current mission planning tools rely on measurements of noise captured by sensor arrays during steady operation. These conventional propeller source noise models are empirical in nature, which limits their capability to estimate the noise produced by the propeller at operating conditions inside the limited measurement database. Therefore, inaccurate estimates are provided when vehicle operations occur at different operational configurations than those measured. These conventional propeller source noise models are further incapable of accurately predicting the effects of operational conditions that are difficult to measure with a conventional system. First-principles propeller noise prediction models exist, but do not have the validated sufficient accuracy to produce reliable estimates of propeller noise spheres required by some target missions.

To address these issues, the embodiments described herein can enable the minimization of propeller noise signature. For example, the accurate characterization of the propeller thrust, and torque captured by, e.g., equations (14) and (15), enables the development of a semi-empirical propeller source noise tool for generating time-domain based, non-dimensionally scaled, propeller acoustic spheres from limited experimental test data. The propeller source noise tool can be a time-domain based hybrid tool, where a mid-fidelity propeller acoustic prediction method can be calibrated to measure data using a parameter identification approach. Accuracy comparable to empirical models can be realized by calibrating the model to the available data. However, the model can be applied to predict noise at conditions that were not measured because it contains a physical model of the propeller noise sources.

In some embodiments, power demand data can be used to train a machine learning model that can be used by a computer system to autonomously perform one or more of the applications described above. As an illustrative example, a machine learning model can be trained based on training data obtained during testing of one or more self-propelled vehicle components (e.g., propeller), which can be used to optimize the design of the one or more self-propelled vehicle components manufactured at operation 232.

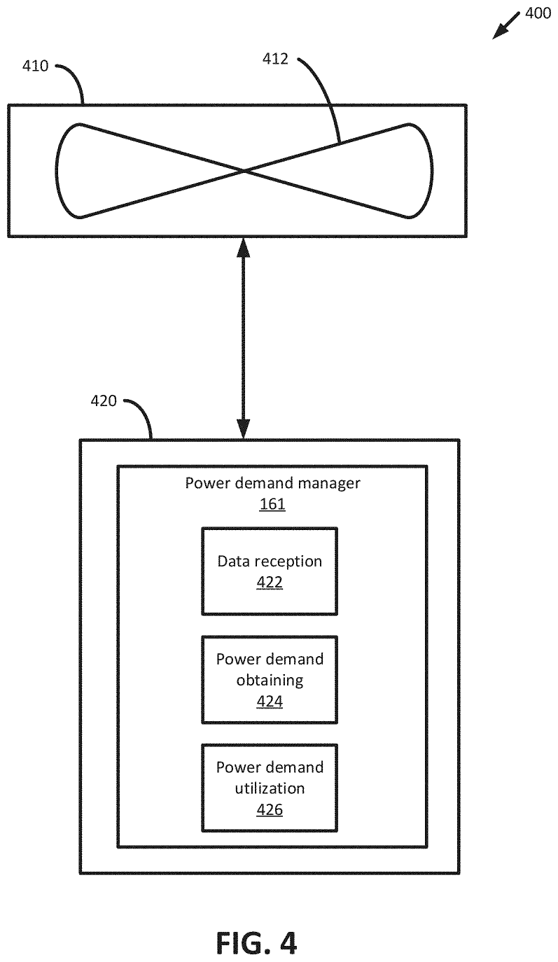

FIG. 4 depicts a block diagram of an example system 400 including a self-propelled vehicle 410 and power demand utilization sub-system (“sub-system”) 420. The self-propelled vehicle 410 includes a propeller 412. The propeller 412 can be any suitable propeller to enable propulsion of the self-propelled vehicle through a fluid medium (e.g., water, air).

In some embodiments, the self-propelled vehicle 410 is a self-propelled vessel. For example, the self-propelled vessel can be a ship, boat, underwater vessel (e.g., submarine), etc. In some embodiments, the self-propelled vehicle 410 is an autonomous or self-driving self-propelled vehicle (AV). For example, the self-propelled vehicle 410 can be an underwater autonomous vehicle (UAV). However, it should be understood and appreciated that self-propelled vehicle 410 can be any other type of self-propelled vehicle capable of propulsion through a fluid medium in accordance with the embodiments described herein (e.g., aerial vehicle).

The sub-system 420 includes the power demand manager 161. More specifically, as shown, the power demand manager 161 can include a number of components, including a data reception component 422, a power demand obtaining component 424, and a power demand utilization component 426. Although shown as separate components, the components 422-426 can be embodied in a single component, as a sub-combination of components, etc. Additionally, one or more of the components 422-426 can be separate from the power demand manager 161.

Parameters associated with the operation of the propeller 412 (e.g., during testing) can be used to generate a set of data associated with the operation of the self-propelled vehicle 410, as described above with reference to FIG. 2. More specifically, data reception component 422 can generate or receive the set of data. The power demand obtaining component 424 can obtain power demand data (e.g., shaft power demand and/or effective power demand) based on the set of data, as described above with reference to FIG. 2. The power demand utilization component 426 can utilize the power demand data within one or more applications related to the self-propelled vehicle, as described above with reference to FIGS. 2-3.

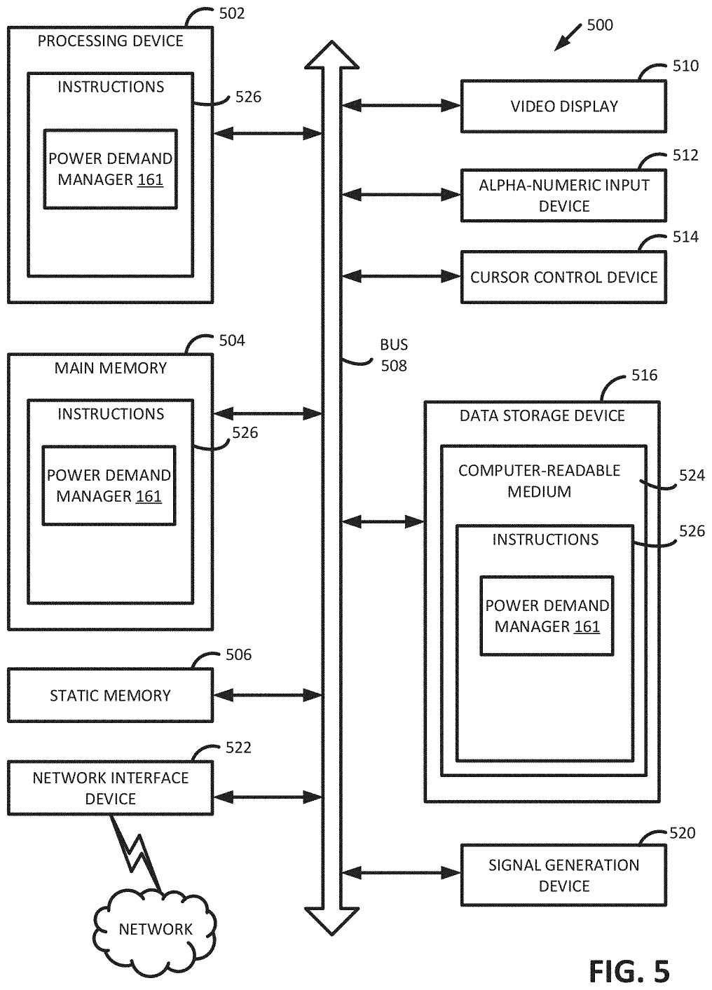

FIG. 5 depicts an example computer system 500 which can perform any one or more of the methods described herein. In one example, computer system 500 may correspond to network architecture 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 516, which communicate with each other via a bus 508.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application-specific integrated circuit (ASIC), a field-programmable gate array (FPGA), a digital signal processor (DSP), network processor, or the like. The processing device 502 is configured to execute processing logic (e.g., instructions 526) that includes power demand manager 161 for performing the operations and steps discussed herein (e.g., corresponding to the method of FIGS. 2 and 3, etc.).

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker). In one illustrative example, the video display unit 510, the alphanumeric input device 512, and the cursor control device 514 may be combined into a single component or device (e.g., an LCD touch screen).

The data storage device 516 may include a non-transitory computer-readable storage medium 524 on which may store instructions 526 that include power demand manager 161 (e.g., corresponding to the method of FIGS. 2 and 3, etc.) embodying any one or more of the methodologies or functions described herein. Power demand manager 161 may also reside, completely or at least partially, within the main memory 504 and/or within the processing device 402 during execution thereof by the computer system 500, the main memory 504 and the processing device 502 also constituting computer-readable media. Power demand manager 161 may further be transmitted or received over a network via the network interface device 522.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Other computer system designs and configurations may also be suitable to implement the systems and methods described herein. The following examples illustrate various implementations in accordance with one or more aspects of the present disclosure.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general-purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A system comprising:
a memory device; and
a processing device, operatively coupled to the memory device, to perform operations comprising:
receiving a set of data associated with operation of a self-propelled vehicle;
obtaining power demand data based on the set of data; and
utilizing the power demand data within one or more applications related to the self-propelled vehicle.

2. The system of claim 1, wherein the set of data comprises a torque curvature parameter, a torque coefficient when a value of a propeller advance ratio associated with a propeller is zero, and a zero-torque propeller advance ratio value, and wherein obtaining the power demand comprises estimating a shaft power demand based in part on the torque curvature parameter, the torque coefficient, and the zero-torque propeller advance ratio value.

3. The system of claim 1, wherein the set of data comprises a thrust curvature parameter, a thrust coefficient when a value of a propeller advance ratio associated with a propeller is zero, and a zero-thrust propeller advance ratio value, and wherein obtaining the power demand comprising estimating an effective power demand based in part on the thrust curvature parameter, the thrust coefficient, and the zero-thrust propeller advance ratio value.

4. The system of claim 1, wherein utilizing the power demand data within one or more applications comprises evaluating a performance of the self-propelled vehicle.

5. The system of claim 1, wherein utilizing the power demand data within one or more applications comprises manufacturing a self-propelled vehicle component.

6. The system of claim 1, wherein the self-propelled vehicle is an autonomous self-propelled vehicle, and wherein utilizing the power demand data within one or more applications comprises enhancing self-propelled vehicle functionality.

7. The system of claim 1, wherein utilizing the power demand data within one or more applications comprises performing automatic draft determination.

8. The system of claim 1, wherein utilizing the power demand data within one or more applications comprises minimizing a propeller noise signature.

9. A method comprising:
receiving, by a processing device, a set of data associated with operation of a self-propelled vehicle;
obtaining, by the processing device, power demand data based on the set of data; and
utilizing, by the processing device, the power demand data within one or more applications related to the self-propelled vehicle.

10. The method of claim 9, wherein the set of data comprises a torque curvature parameter, a torque coefficient when a value of a propeller advance ratio associated with a propeller is zero, and a zero-torque propeller advance ratio value, and wherein obtaining the power demand comprises estimating a shaft power demand based in part on the torque curvature parameter, the torque coefficient, and the zero-torque propeller advance ratio value.

11. The method of claim 9, wherein the set of data comprises a thrust curvature parameter, a thrust coefficient when a value of a propeller advance ratio associated with a propeller is zero, and a zero-thrust propeller advance ratio value, and wherein obtaining the power demand comprising estimating an effective power demand based in part on the thrust curvature parameter, the thrust coefficient, and the zero-thrust propeller advance ratio value.

12. The method of claim 9, wherein utilizing the power demand data within one or more applications comprises evaluating a performance of the self-propelled vehicle.

13. The method of claim 9, wherein utilizing the power demand data within one or more applications comprises manufacturing a self-propelled vehicle component.

14. The method of claim 9, wherein the self-propelled vehicle is an autonomous self-propelled vehicle, and wherein utilizing the power demand data within one or more applications comprises enhancing self-propelled vehicle functionality.

15. The method of claim 9, wherein utilizing the power demand data within one or more applications comprises performing automatic draft determination.

16. The method of claim 9, wherein utilizing the power demand data within one or more applications comprises minimizing a propeller noise signature.

17. A non-transitory computer-readable storage medium comprising instructions that, when executed by a processing device, cause the processing device to perform operations comprising:
receiving a set of data associated with operation of a self-propelled vehicle;
obtaining power demand data based on the set of data; and
utilizing the power demand data within one or more applications related to the self-propelled vehicle.

18. The non-transitory computer-readable storage medium of claim 17, wherein the set of data comprises a torque curvature parameter, a torque coefficient when a value of a propeller advance ratio associated with a propeller is zero, and a zero-torque propeller advance ratio value, and wherein obtaining the power demand comprises estimating a shaft power demand based in part on the torque curvature parameter, the torque coefficient, and the zero-torque propeller advance ratio value.

19. The non-transitory computer-readable storage medium of claim 17, wherein the set of data comprises a thrust curvature parameter, a thrust coefficient when a value of a propeller advance ratio associated with a propeller is zero, and a zero-thrust propeller advance ratio value, and wherein obtaining the power demand comprising estimating an effective power demand based in part on the thrust curvature parameter, the thrust coefficient, and the zero-thrust propeller advance ratio value.

20. The non-transitory computer-readable storage medium of claim 17, wherein utilizing the power demand data within one or more applications comprises at least one of:
evaluating a performance of the self-propelled vehicle;
manufacturing a self-propelled vehicle component;
enhancing self-propelled vehicle functionality;
performing automatic draft determination; or
minimizing a propeller noise signature.
